(19) United States
(12) Patent Application Publication
(10) Pub. No.: US 2024/0424626 A1
(43) Pub. Date: Dec. 26, 2024

(54) Automated Selection of Cutting Tools

(71) Applicant: The Boeing Company, Arlington, VA (US)

(72) Inventor: Justin Lee Peters, Carrollton, IL (US)

(21) Appl. No.: 18/341,638

(22) Filed: Jun. 26, 2023

(51) Int. Cl. B23Q 3/155

(52) U.S. Cl. CPC B23Q 3/15503

(57) ABSTRACT

A method of tool and parameter selection is presented. Tap test data is generated for a machine by performing tap testing on the machine with a plurality of tools. Geometric features of a part to be machined in a workpiece by the machine are extracted. The plurality of tools is filtered by applying a series of rules based on the geometric features of the part to identify a selected tool for a machining operation to form the part. In some illustrative examples, cutting parameters are set for the machining operation using the tap test data for the machine with the selected tool.

### BACKGROUND INFORMATION

### 1. Field

The present disclosure relates generally to manufacturing and more specifically to selection of cutting tools for manufacturing.

### 2. Background

Traditionally cutting tools are selected manually for each manufacturing sequence by an engineer and/or machinist based on their experiences. Traditionally the cutting parameters are selected based on engineering knowledge for speed and feeds. Each cutting parameter can change based on the human input. Other approaches to machining have provided fixed libraries and templates of operations. Fixed libraries and templates have drawbacks for automation because the output is manual, can vary depending on the engineer and/or machinist, and are not adaptable to new geometry and available cutting tools in a machine.

Therefore, it would be desirable to have a method and apparatus that takes into account at least some of the issues discussed above, as well as other possible issues.

### SUMMARY

An embodiment of the present disclosure provides a method of tool and parameter selection. Tap test data for a machine is generated by performing tap testing on the machine with a plurality of tools. Geometric features of a part to be machined in a workpiece by the machine are extracted from a design of the part. The plurality of tools is filtered by applying a series of rules based on the geometric features of the part to identify a selected tool for a machining operation to form the part. Cutting parameters for the machining operation are set using the tap test data for the machine with the selected tool.

Another embodiment of the present disclosure provides a tool and cutting parameter selection system. The tool and cutting parameter selection system comprises a database populated with tool parameters and tool attributes for a plurality of tools and tap test data generated through tap testing for a machine with the plurality of tools, a geometry analyzer configured to extract geometric features for a part to be machined in a workpiece, a tool filter configured to apply a series of rules based on geometric features to identify a selected tool for machining operations to form the part in the workpiece, and a cutting parameter selector configured to set cutting parameters based on the selected tool and the tap test data.

Yet another embodiment of the present disclosure provides a method of tool and parameter selection. A design for a part to be machined in a workpiece is received. Geometric features are extracted from the design of the part to be machined in the workpiece. The plurality of tools is filtered by applying a series of rules based on the geometric features to identify a selected tool for a machining operation to be performed by a machine. The cutting parameters for the machining operation are set using tap test data for the machine with the selected tool.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a machined part in a workpiece in accordance with an illustrative embodiment;

FIG. 4 is an illustration of a cross-sectional view of a tool and a machine in relation to a feature in a part in accordance with an illustrative embodiment;

FIG. 5 is an illustration of a top view of a tool and in relation to a feature in a part in accordance with an illustrative embodiment;

FIG. 6 is an illustration of a cross-sectional view of a feature in a part and a in accordance with an illustrative embodiment;

FIGS. 7A and 7B are a flowchart of a method of tool and parameter selection in accordance with an illustrative embodiment;

FIG. 8 is a flowchart of a method of tool and parameter selection in accordance with an illustrative embodiment;

FIG. 9 is an illustration of an aircraft manufacturing and service method in a form of a block diagram in accordance with an illustrative embodiment; and

FIG. 10 is an illustration of an aircraft in a form of a block diagram in which an illustrative embodiment may be implemented.

### DETAILED DESCRIPTION

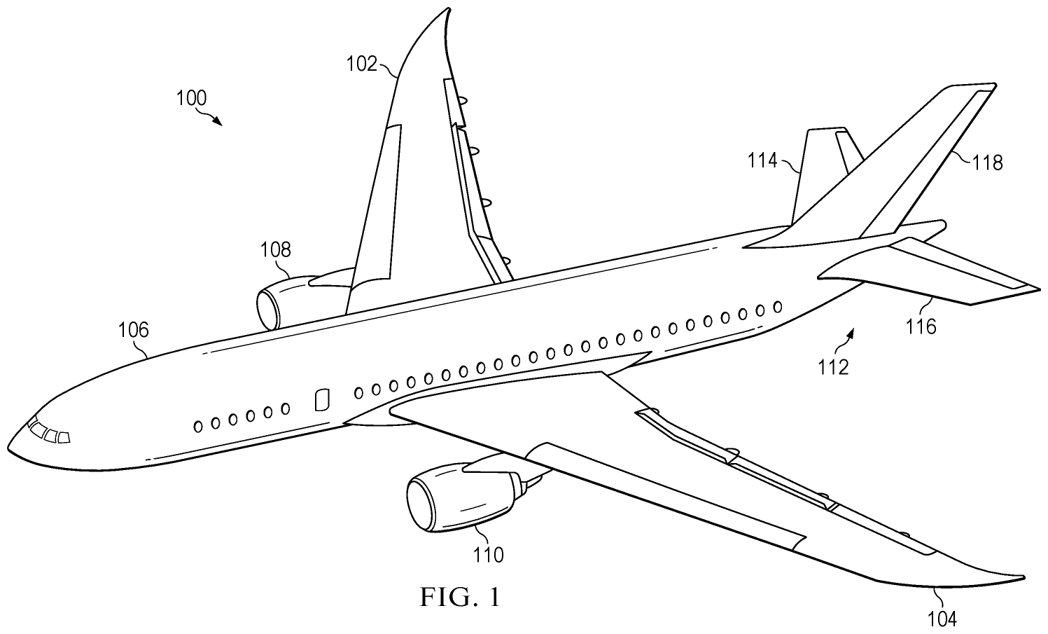

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have a component machined using a tool and cutting parameters selected by a tool and cutting parameter selection method of the illustrative examples. The illustrative examples can be used to select a tool and cutting parameters for machining a part of aircraft 100. The illustrative examples can be used to reduce at least one of cost or inventory in manufacturing aircraft 100 by utilizing tools that are standardized for the machine and process rather than having unlimited selection of tools and types.

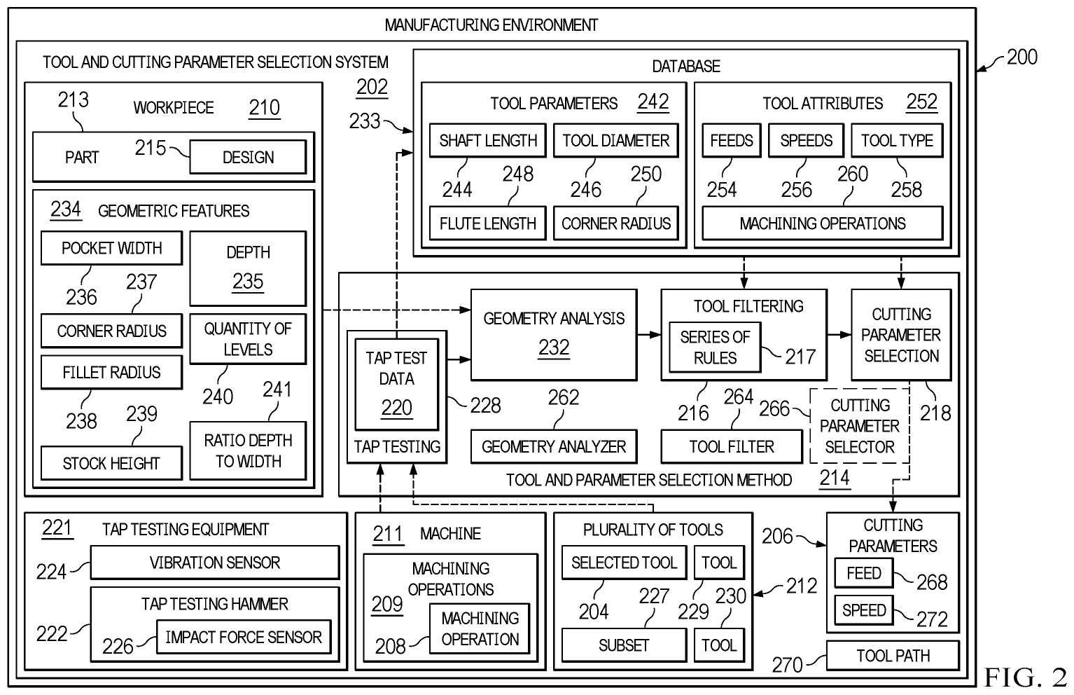

Turning now to FIG. 2, an illustration of a block diagram of a manufacturing environment is depicted in accordance with an illustrative embodiment. Tool and cutting parameter selection system 202 in manufacturing environment 200 can be used to select a tool and cutting parameters for machining a part of aircraft 100 of FIG. 1.

Tool and cutting parameter selection system 202 selects selected tool 204 and cutting parameters 206 for performing machining operation 208 on workpiece 210. Machining operation 208 is one of machining operations 209 that can be performed by machine 211. Machine 211 performs machining operation 208 on workpiece 210 to form part 213. Machining operation can include at least one of roughing (such as Z level roughing or rest roughing), floor finishing), wall finishing, or rest finishing. Floor finishing can be used to form flange top or floors. Rest finishing can be used to form small corners or fillets. Tool and cutting parameter selection system 202 selects selected tool 204 from plurality of tools 212.

Tool and parameter selection method 214 selects selected tool 204 and sets cutting parameters 206. Tool and parameter selection method 214 performs tool filtering 216 and cutting parameter selection 218 to automate set-up of machining operation 208. Cutting parameter selection 218 utilizes tap test data 220.

Tap test data 220 is generated for machine 211 holding each of plurality of tools 212. Tap test data 220 is generated using tap testing equipment 221. Tap testing equipment 221 includes tap testing hammer 222, vibration sensor 224, and impact force sensor 226.

Tap test data 220 is generated by striking tap testing hammer 222 against a respective tool in machine 211. Vibration sensor 224 is attached to the tool and records vibrations in the tool. Impact force sensor 226 is connected to tap testing hammer 222 to record the force of tap testing hammer 222 against the tool. The tool is one of plurality of tools 212. In some illustrative examples, tool and cutting parameter selection system 202 includes vibration sensor 224 configured to attach to a tool, such as tool 229 or tool 230, of the plurality of tools 212 during tap testing 228 and impact force sensor 226 associated with tap testing hammer 222.

Tap testing 228 is performed for machine 211 with each tool of plurality of tools 212. For example, tap testing 228 can be performed on tool 229 in machine 211, tool 230 in machine 211, and selected tool 204 in machine 211. Afterwards, tap test data 220 is stored in database 233.

The illustrative examples provide a cutting tools technical database, database 233, with links to tap test data 220 and cutting testing to apply cutting speeds and feed into a technical database. Dynamic tap tests, tap testing 228, are conducted with the cutting tool assembly, a tool of plurality of tools 212, loaded in the spindle of machine 211. The respective tool of plurality of tools 212 is struck with a small soft tip hammer, tap testing hammer 222, on the bottom of the flute. The frequency that it vibrates is then captured and plotted to determine an rpm that is stable. Then a microphone utilized in cut test to determine depth of cut that are chatter free. The optimal cutting parameters are captured and linked as xml dynamic tap test data in a technical database and can be extracted. This is novel because it is a scientific approach that ensures stable machining parameters and is proven rather than being dependent on an engineer and/or machinist tribal knowledge.

In some illustrative examples, tool and parameter selection method 214 performs geometry analysis 232. Geometry analysis 232 extracts geometric features 234 of part 213 to be machined in workpiece 210 by machine 211. Geometry analysis 232 extracts geometric features 234 of part 213 from design 215 of part 213. Geometric features 234 include at least one of depth 235, pocket width 236, corner radius 237, fillet radius 238, stock height 239, quantity of levels 240, or ratio depth to width 241. In some illustrative examples, pocket width 236 is a maximum pocket width. In some illustrative examples, pocket width 236 is a minimum pocket width.

In some illustrative examples, filtering plurality of tools 212 is performed by applying series of rules 217 based on geometric features 234 of part 213 to identify a selected tool for machining operation 208 to form part 213. In some illustrative examples, geometric features 234 are determined for part 213 prior to selecting series of rules 217 based on machining operation 208. In some illustrative examples, geometric features 234 are determined for a whole of part 213 prior to performing tool filtering 216 and independent of series of rules 217. In some illustrative examples, geometric features 234 are determined for only a portion of part 213.

In some illustrative examples, geometric features 234 are determined based on series of rules 217 for tool filtering 216. For example, fillet radius 238 may not be relevant to some of machining operations 209. In some illustrative examples, fillet radius 238 is not generated for tool filtering 216. In some illustrative examples, geometric features 234 are generated in response to a reference to the respective geometric feature in series of rules 217.

Plurality of tools 212 is filtered to determine selected tool 204. Plurality of tools 212 is filtered by applying series of rules 217 based on geometric features 234 of part 213 to identify selected tool 204 for machining operation 208 to form part 213. Series of rules 217 utilizes at least one of geometric features 234, tool parameters 242, or tool attributes 252.

Each rule of series of rules 217 is based on a machining operation of machining operations 209. Different machining operations of machining operations 209 will have different rules. For example, floor finishing machining operations will have different rules for selection of selected tool 204 than wall finishing operation.

Tool parameters 242 include shaft length 244, tool diameter 246, flute length 248, and corner radius 250. Tool attributes 252 include feeds 254, speeds 256, tool type 258, and machining operations 260. In some illustrative examples, tool parameters 242 and tool attributes 252 are provided by the manufacturer of the respective tool. Which tool parameter of tool parameters 242 is utilized in a respective rule of series of rules 217 is dependent on the type of machining operation to be performed.

Each of series of rules 217 is applied to reduce possible tools to be used for a machining operation, such as machining operation 208, from plurality of tools 212. In some illustrative example, each of series of rules 217 will reduce a quantity of possible tools for machining operation 208. For example, by applying a rule of series of rules 217, possible tools to perform machining operation 208 can be reduced from plurality of tools 212 to subset 227. In some illustrative examples, subset 227 has the same quantity of tools as plurality of tools 212. In some illustrative examples, subset 227 has a smaller quantity of tools than plurality of tools 212. After applying each rule of series of rules 217, a respective quantity of tools in subset 227 of tools is reduced or remains the same. Any tools of plurality of tools 212 that do not meet a rule of a series of rules, is removed from subset 227.

In some illustrative examples, extracting geometric features 234 of part 213 comprises identifying a smallest corner radius of a feature of part 213. The feature of part 213 is formed using machining operation 208. In some illustrative examples, filtering the plurality of tools 212 comprises applying a rule of series of rules 217 that reduces plurality of tools 212 to a subset based on the smallest corner radius and diameters of the plurality of tools 212. For example, tool diameter 246 of a respective tool, such as tool 229, is compared to corner radius 237, in which corner radius 237 is a smallest corner radius. If half of tool diameter 246 (a tool radius) is larger than corner radius 237, tool 229 is removed from consideration for machining operation 208. A rule of series of rules 217 is applied to each of plurality of tools 212 to identify an optimized tool. For example, a rule including corner radius 237, in which corner radius 237 is a smallest corner radius, is applied to tool 229, tool 230, and selected tool 204. Selected tool 204 is the tool resulting from performing tool filtering 216, including that rule.

In some illustrative examples, extracting geometric features 234 of part 213 comprises identifying a minimum pocket width of part 213. In some illustrative examples, filtering plurality of tools 212 comprises applying a rule of series of rules 217 that reduces plurality of tools 212 to a subset based on the minimum pocket width and diameters of the plurality of tools 212. For example, tool diameter 246 of a respective tool, such as tool 229, is compared to pocket width 236, in which pocket width 236 is a smallest pocket width. If tool diameter 246 is larger than pocket width 236, tool 229 is removed from consideration for machining operation 208.

In some illustrative examples, extracting geometric features 234 of part 213 comprises identifying a smallest corner fillet radius 238 of a feature of part 213. In some illustrative examples, filtering plurality of tools 212 comprises applying a rule of series of rules 217 that reduces plurality of tools 212 to a subset based on the smallest corner fillet radius 238 and corner radiuses of the plurality of tools 212. For example, corner radius 250 of a respective tool, such as tool 229, is compared to fillet radius 238, in which fillet radius 238 is a smallest fillet radius. If corner radius 250 is less than or equal to fillet radius 238, tool 229 remains an option for machining operation 208.

In some illustrative examples, tap test data 220 is saved in a technical database, database 233, with tool parameters 242 and tool attributes 252 for plurality of tools 212, associating respective tap test data 220 with each of the plurality of tools 212. In some illustrative examples, at least one rule of series of rules 217 is based on the tap test data 220. For example, in some rules of series of rules 217, an assumed speed can be based on tool diameter 246. In other illustrative examples, rules of series of rules 217 utilizes speeds calculated using tap test data 220.

In some illustrative examples, tool and parameter selection method 214 sets cutting parameters 206 for machining operation 208 using tap test data 220 for machine 211 with selected tool 204. In these illustrative examples, after identifying selected tool 204, cutting parameters 206 are set based on tap test data 220.

Cutting parameter selector 266 utilizes tap test data 220 to select cutting parameters 206 to maintain quality of part 213 and meet set goals. In some illustrative examples, the set goals can include a time goal. In some illustrative examples, cutting parameter selector 266 sets cutting parameters 206 to minimize machining time while preventing chatter. Cutting parameters 206 can include feed 268 and speed 272. Feed 268 is a distance traveled by selected tool 204 in one revolution of selected tool 204. Feed 268 can also be referred to as a feed rate. Speed 272 is the relative velocity between selected tool 204 and the surface of workpiece 210. Speed 272 can be referred to as a cutting speed.

In some illustrative examples, generating a tool path 270 for performing the machining operation using the selected tool and the cutting parameters.

In some illustrative examples, generating additional tap test data 220 for the machine by performing tap testing 228 on the machine with a new tool. By performing tap testing 228 on each new tool, every possible tool can be scientifically evaluated for machining operations 209. The new tool is added to plurality of tools 212 to increase a quantity of tools in plurality of tools 212.

In some illustrative examples, setting cutting parameters 206 for machining operation 208 comprises setting cutting parameters 206 to machine part 213 in a shortest period of time without chatter. Utilizing tap test data 220 in setting cutting parameters 206 provides a scientific method of performing machining operation 208 without chatter. Tap test data 220 provides a plurality of possible speeds for selected tool 204 that can be used without chatter.

In some illustrative examples, a database populated with tool parameters and tool attributes for a plurality of tools 212 and tap test data 220 generated through tap testing 228 for a machine with the plurality of tools 212; a geometry analyzer configured to extract geometric features for a part to be machined in a workpiece; a tool filter configured to apply a series of rules based on geometric features to identify a selected tool for machining operations to form the part in the workpiece; a cutting parameter selector configured to set cutting parameters based on the selected tool and the tap test data 220.

The illustrative examples provide a method to automatically select optimized cutting tools and cutting parameters for rapid manufacturing process. Selecting cutting tools for a manufacturing process traditionally utilizes the knowledge of an engineer and/or machinist. The illustrative examples apply standardization to the process by focusing the scope of cutting tools that are available to a machine.

One example of a number of rules of series of rules 217 includes a roughing rule. One illustrative example of a roughing rule includes: 1) only use tools in the data base that activated as rough, 2) Only tools where shaft length+StockToLeave>Max depth 3) only use BullMill tools, 4) The biggest tool (diameter)+2*StockToLeave that is <max pocket width, 5) When multiple tool fit the criteria above select the shortest solution from the tool library as the preferred tool. Only use tools in database 233 that are activated as rough includes filtering by machining operations 260. In the second step, shaft length 244 is compared to depth 235 of geometric features 234 of part 213. In the third step, tool type 258 is used to filter plurality of tools 212 to only bullmill tools. In the fourth step, tool diameter 246 is compared to pocket width 236 to filter plurality of tools 212. In the fifth step, shaft length 244 is compared between any remaining tools in plurality of tools 212.

The illustrative examples can be implemented in a software plugin. The illustrative examples are designed to automate creating CAM operations to automatically machine parts. The illustrative examples provide tool and cutting parameter selection system 202 in which a user only provides minimal information about workpiece 210 in the user interface (UI). In the illustrative examples, all machining operations 209, the selection of the tools for each of machining operations 209 from plurality of tools 212, cutting parameters 206, and the sequence of machining operations 209 is automatically generated by the illustrative examples.

The development of a new database format for database 233 to store cutting parameters and geometry information is complete and can be constructed in the XML (Extensible Markup Language) format. The cutting tool library database, database 233, is associated to tool filter 264.

In some illustrative examples, geometry analyzer 262 can receive input from a user to specify part geometries, trim surfaces, stock, fixtures, and associate numeric variables to each input. In other illustrative examples, a dedicated user interface (not depicted) of tool and cutting parameter selection system 202 allows a user to specify part geometries, trim surfaces, stock, fixtures, and associate numeric variables to each input. In some illustrative examples, a user can specify how many levels part 213 should be machined as well as the ratio depth to thickness. In some illustrative examples, for tool and parameter selection method 214, user defined geometry input includes part 213, stock (workpiece 210), a fixture, and a split surface.

A machining parameter section can provide a user machining methods and parameters to adapt to various types of geometries. For instance, when part 213 presents itself with undercuts the user can check the box and kernel will automatically select appropriate machining operations 209 while allowing for additional user input of alternate machining directions. Machining parameters can include undercuts for additional machining directions, Max Tilt Angle for machine capabilities, Roughing Axial Offset Parameter, floor finishing Stepover Parameter, wall finishing alternate methods and parameters, and rest finishing parameters.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, in some illustrative examples, geometry analysis 232 can be performed at the same time as or as a part of tool filtering 216. For example, geometry analyzer 262 may identify geometric features 234 in response to series of rules 217 during tool filtering 216. Geometry analysis 232 can be performed to only identify geometric features 234 relevant to series of rules 217.

As another example, a user interface with display and input device can be provided in tool and cutting parameter selection system 202. An input device can take any desirable form such as a keyboard, mouse, touch display, or any other desirable method of input. The display can include a monitor, a screen, a projection, or any other desirable type of display. In some illustrative examples, after performing tool and parameter selection method, a Machining Sequence is provided as a preview of the operations to a user. The machining sequence can include the assigned tools and the machining sequence that is going to be created for part 213.

The illustrative examples enable an automatic selection wizard of a pre-defined machining operation. A user can provide design 215 of part 213 and any desired user defined geometric input. The sequences and cutting tools of plurality of tools 212 are selected based on geometric features 234 and cutting parameters 206 defined in series of rules 217. In some illustrative examples, machining operations 209 can include at least one of roughing, such as Z level roughing or rest roughing, floor finishing for Flange Top or Floors, wall finishing for Z level finishing, or rest finishing (Small Corners/Fillets).

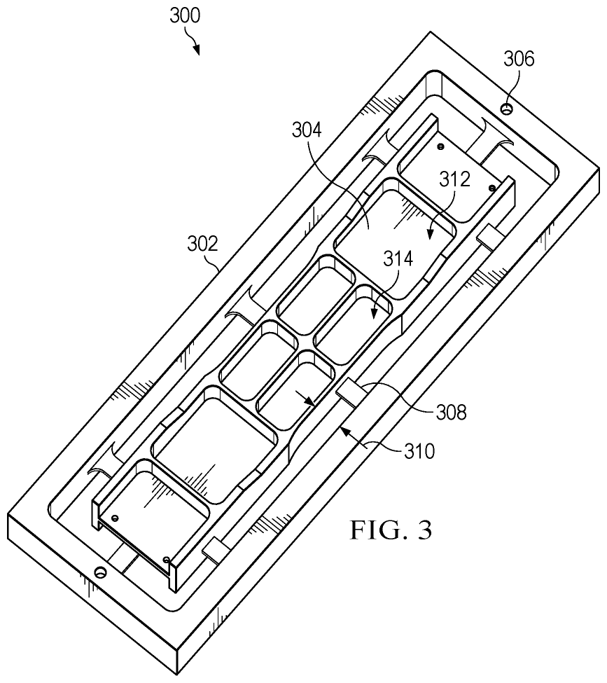

Turning now to FIG. 3, an illustration of a machined part in a workpiece in accordance with an illustrative embodiment. Part 300 in workpiece 302 is a physical implementation of part 213 of FIG. 2. Part 300 can be a component of aircraft 100 of FIG. 1. Part 300 can be machined by selected tool 204 in machine 211 of FIG. 2.

Tooling hole 306 is used to secure workpiece 302 for machining. By securing workpiece 302 for machining, part 304 can be formed in workpiece 302. Part 304 is connected to workpiece 302 by work holding tabs 308. Channel 310 separates part 304 and workpiece 302.

Features, such as feature 312 and feature 314, are machined into workpiece 302 to form part 304. Any desirable machining operations can be performed on workpiece 302 to form part 304.

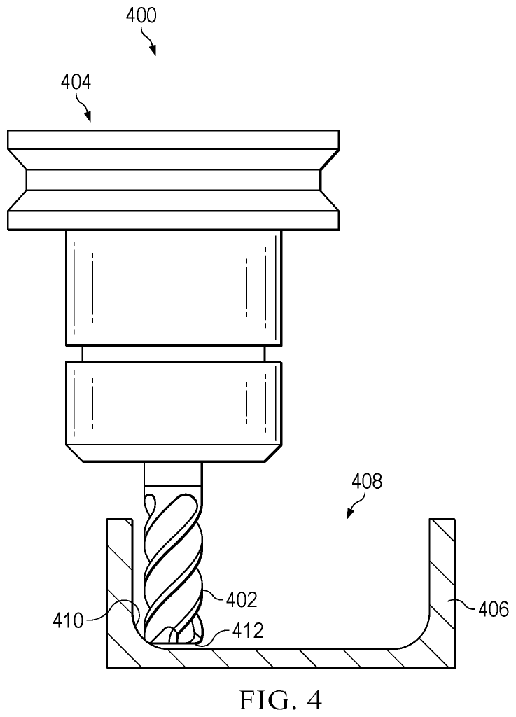

Turning now to FIG. 4, an illustration of a cross-sectional view of a tool and a machine in relation to a feature in a part in accordance with an illustrative embodiment. View 400 is a physical illustration of tool filtering 216 of FIG. 2 based on geometry analysis 232 of FIG. 2.

In view 400, tool 402 is represented in machine 404. Part 406 has feature 408. Feature 408 has smallest fillet radius 410. Smallest fillet radius 410 is an example of a geometric feature of geometric features 234 of FIG. 2 that can be used in series of rules 217 of FIG. 2. Tool 402 has corner radius 412. In some illustrative examples, the largest tool corner radius is less than or equal to smallest fillet radius 410. In this illustrative example, tool 402 would pass the tool filtering rule of a tool corner radius being less than or equal to smallest fillet radius 410. Corner radius 412 of tool 402.

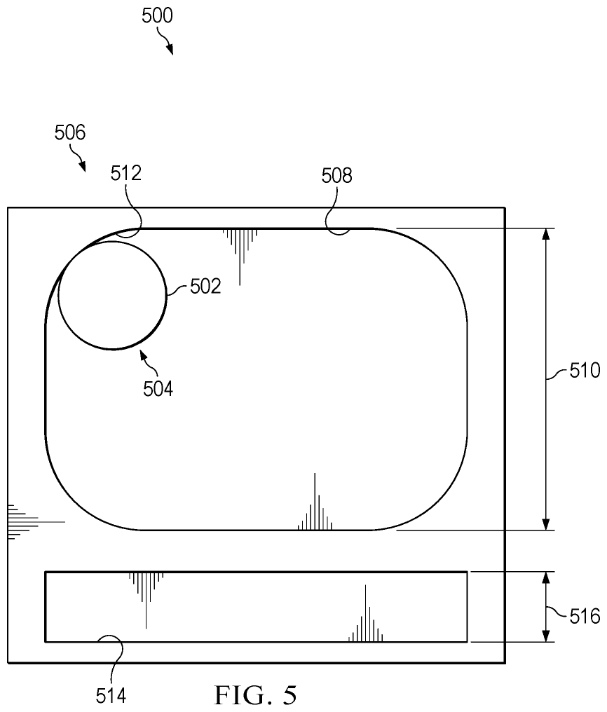

Turning now to FIG. 5, an illustration of a top view of a tool and in relation to a feature in a part in accordance with an illustrative embodiment. View 500 is a physical illustration of tool filtering 216 of FIG. 2 based on geometry analysis 232 of FIG. 2.

In view 500, part 506 to be machined is depicted. Part 506 has feature 508 and feature 514. To determine a selected tool to perform a machining operation to form part 506, geometric features of part 506 are determined. In some illustrative examples, a single tool will perform machining operations to form feature 508 and feature 514. In some illustrative examples, more than one operation will be performed to form feature 508 and feature 514.

Feature 508 has maximum pocket width 510 of part 506. Maximum pocket width 510 of part 506 is an example of a geometric feature of geometric features 234 of FIG. 2 that can be used in series of rules 217 of FIG. 2. For example, a tool diameter can be selected based on maximum pocket width 510. In some illustrative examples, a tool diameter is maximized while taking into account at least one of quality concerns or other features of part 506.

Feature 508 has smallest corner radius 512. Smallest corner radius 512 is a smallest corner radius for a layer of part 506. Smallest corner radius 512 of part 506 is an example of a geometric feature of geometric features 234 of FIG. 2 that can be used in series of rules 217 of FIG. 2.

In view 500, tool 502 is represented as circle 504 for simplicity. Circle 504 is depicted to illustrate how a diameter of tool 502 effects smallest corner radius 512.

Part 506 has feature 514 with minimum pocket width 516 of part 506. Minimum pocket width 516 is an example of a geometric feature of geometric features 234 of FIG. 2 that can be used in series of rules 217 of FIG. 2. For example, a tool diameter can be selected such that the largest tool diameter is less than minimum pocket width 516. At least one of maximum pocket width 510 or minimum pocket width 516 can be relevant to tool filtering rules set for at least one of floor finishing, wall finishing, or roughing. Smallest corner radius 512 can be relevant to tool filtering rules set for at least one of floor finishing, wall finishing, or roughing.

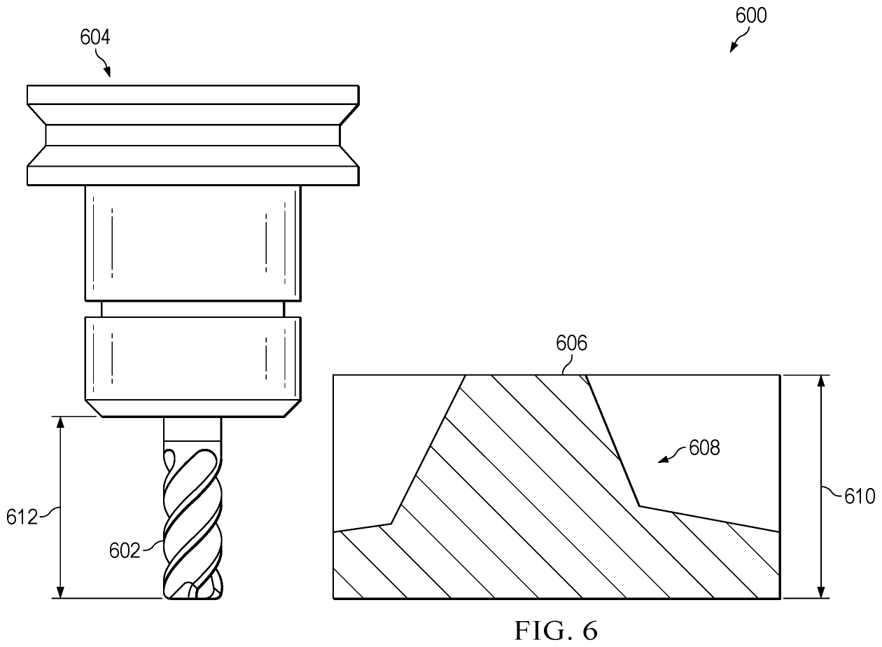

Turning now to FIG. 6, an illustration of a cross-sectional view of a feature in a part and a tool in accordance with an illustrative embodiment. Part 606 can be a part of aircraft 100 of FIG. 1. Part 606 can be a physical implementation of part 213 of FIG. 2. Tool 602 is a physical implementation of one of plurality of tools 212 of FIG. 2. In some illustrative examples, part 606 can be the same as part 304 of FIG. 3. In some illustrative examples, part 606 can be the same as part 406 of FIG. 4. In some illustrative examples, part 606 can be the same as part 506 of FIG. 5.

View 600 is a cross-sectional view of part 606 with feature 608. In view 600, tool 602 is one of the plurality of tools available for use in machine 604. Tool 602 and machine 604 are depicted to depict shaft length 612. Shaft length 612 is relevant to maximum depth 610 of part 606.

In some machining operations, a rule of the series of rules to filter the plurality of tools includes a rule that the shaft length is greater than maximum depth 610 of part 606. As depicted, shaft length 612 is shorter than maximum depth 610 of part 606. In tooling filtering in which a rule of only tools where shaft length>max depth, tool 602 would be eliminated as shaft length 612 is less than maximum depth 610. Maximum depth 610 can be relevant to tool filtering rules set for at least one of floor finishing, wall finishing, or roughing.

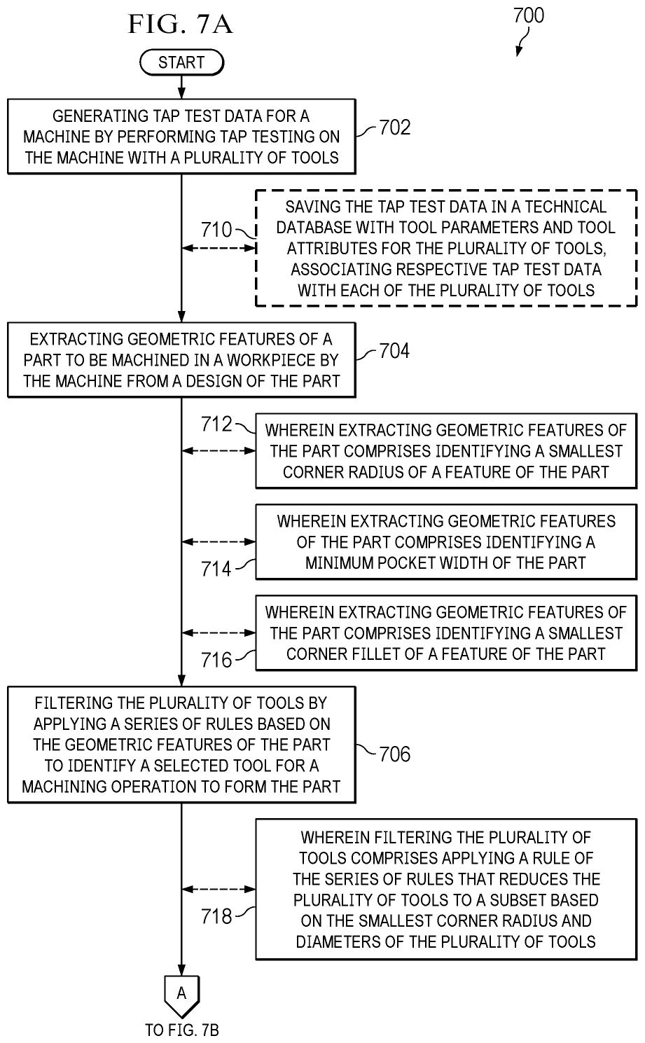

Turning now to FIGS. 7A and 7B, a flowchart of a method of tool and parameter selection in accordance with an illustrative embodiment. Method 700 can be used to select tools for machining parts of aircraft 100 of FIG. 1. Method 700 can be performed using tool and cutting parameter selection system 202 of FIG. 2. Method 700 can be one implementation of tool and parameter selection method 214 of FIG. 2. Method 700 can be performed to select a tool and cutting parameters for forming at least one of feature of part 304 of FIG. 3. Method 700 can be performed to select a tool and cutting parameters for forming feature 408 in part 406. Method 700 can be performed to select a tool and cutting parameters to form at least one of feature 508 or feature 514 in part 506 of FIG. 5. Method 700 can be performed to select a tool and cutting parameters to form feature 608 in part 606 of FIG. 6.

Method 700 generates tap test data for a machine by performing tap testing on the machine with a plurality of tools (operation 702). Method 700 extracts geometric features of a part to be machined in a workpiece by the machine from a design of the part (operation 704). Method 700 filters the plurality of tools by applying a series of rules based on the geometric features of the part to identify a selected tool for a machining operation to form the part (operation 706). Method 700 sets cutting parameters for the machining operation using the tap test data for the machine with the selected tool (operation 708). Afterwards, method 700 terminates.

In some illustrative examples, method 700 saves the tap test data in a technical database with tool parameters and tool attributes for the plurality of tools, associating respective tap test data with each of the plurality of tools (operation 710). In some illustrative examples, extracting geometric features of the part comprises identifying a smallest corner radius of a feature of the part (operation 712). In some illustrative examples, filtering the plurality of tools comprises applying a rule of the series of rules that reduces the plurality of tools to a subset based on the smallest corner radius and diameters of the plurality of tools (operation 718).

In some illustrative examples, extracting geometric features of the part comprises identifying a minimum pocket width of the part (operation 714). In some illustrative examples, filtering the plurality of tools comprises applying a rule of the series of rules that reduces the plurality of tools to a subset based on the minimum pocket width and diameters of the plurality of tools (operation 720).

In some illustrative examples, extracting geometric features of the part comprises identifying a smallest corner fillet radius of a feature of the part (operation 716). In some illustrative examples, filtering the plurality of tools comprises applying a rule of the series of rules that reduces the plurality of tools to a subset based on the smallest corner fillet radius and corner radiuses of the plurality of tools (operation 722).

In some illustrative examples, method 700 generates a tool path for performing the machining operation using the selected tool and the cutting parameters (operation 724). In some illustrative examples, at least one rule of the series of rules is based on the tap test data (operation 726). In some illustrative examples, a rule regarding speed is based on the tap test data.

In some illustrative examples, generating additional tap test data for the machine by performing tap testing on the machine with a new tool (operation 728). In these illustrative examples, newly procured tools can have tap test data present for analysis. Tap test data can be generated whenever additional tools are procured for the machine. In some illustrative examples, setting cutting parameters for the machining operation comprises setting cutting parameters to machine the part in a shortest period of time without chatter (operation 730).

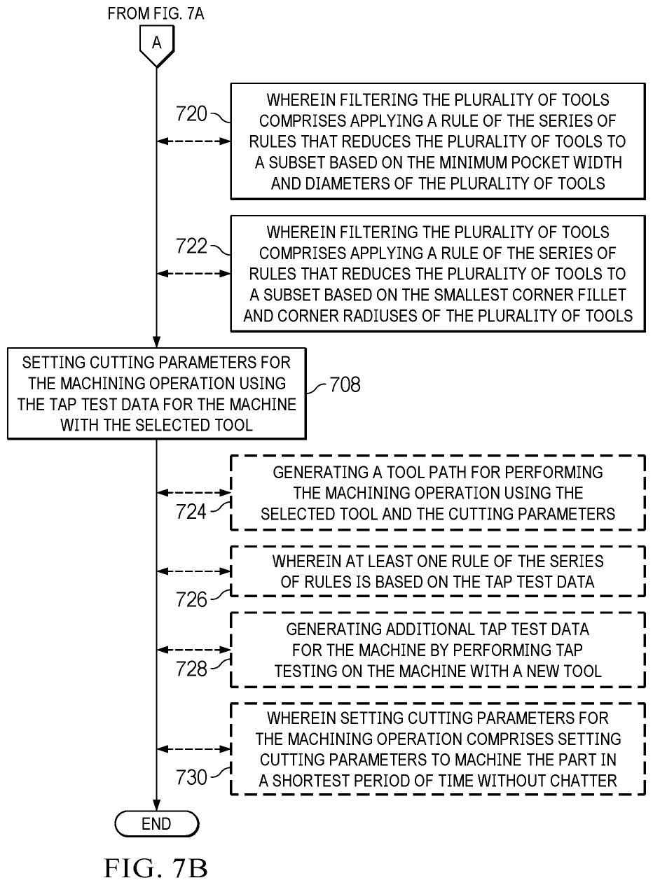

Turning now to FIG. 8, a flowchart of a method of tool and parameter selection is depicted in accordance with an illustrative embodiment. Method 800 can be used to select tools for machining parts of aircraft 100 of FIG. 1. Method 800 can be performed using tool and cutting parameter selection system 202 of FIG. 2. Method 800 can be one implementation of tool and parameter selection method 214 of FIG. 2. Method 800 can be performed to select a tool and cutting parameters for forming at least one of feature of part 304 of FIG. 3. Method 800 can be performed to select a tool and cutting parameters for forming feature 408 in part 406. Method 800 can be performed to select a tool and cutting parameters to form at least one of feature 508 or feature 514 in part 506 of FIG. 5. Method 800 can be performed to select a tool and cutting parameters to form feature 608 in part 606 of FIG. 6.

A design for a part to be machined in a workpiece is received (operation 802). In some illustrative examples, the design is a three-dimensional model of the part. In some illustrative examples, the design is a series of measurements or a series of data points. In some illustrative examples, the design includes data saved in one of a database or a matrix.

Geometric features are extracted from the design of the part to be machined in the workpiece (operation 804). In some illustrative examples, the geometric features include maximum and minimum values for features of the part.

The plurality of tools are filtered by applying a series of rules based on the geometric features to identify a selected tool for a machining operation to be performed by a machine (operation 806). In some illustrative examples, the series of rules is selected based on the machining operation to be performed on the workpiece to form the part. In some illustrative examples, the series of rules is programmed prior to selection of the tool.

Cutting parameters are set for the machining operation using tap test data for the machine with the selected tool (operation 808). Afterwards, method 800 terminates.

In some illustrative examples, method 800 generates a tool path for performing the machining operation using the selected tool and the cutting parameters (operation 820). In some illustrative examples, the tool path is generated based on quality considerations. In some illustrative examples, the tool path is generated to reduce the machining time spent in performing the machining operation.

In some illustrative examples, filtering the plurality of tools comprises applying the series of rules based on a smallest corner radius and a smallest fillet radius (operation 810). In some illustrative examples, filtering the plurality of tools comprises applying the series of rules based on at least one of a smallest pocket width or a largest pocket width of the part (operation 812).

In some illustrative examples, filtering the plurality of tools comprises applying the series of rules based on a maximum depth of machining for the part (operation 814). In some illustrative examples, filtering the plurality of tools comprises selecting possible tools based on a shaft length of the tools.

In some illustrative examples, at least one rule of the series of rules is based on the tap test data (operation 816). In some illustrative examples, the tap test data can be utilized to determine acceptable speeds for use of the respective tool. In some of these illustrative examples, the tap test data can be used in selecting a tool for performing the machining operation based on speed.

In some illustrative examples, setting cutting parameters for the machining operation comprises setting cutting parameters to machine the part in a shortest period of time without chatter (operation 818). By using the tap test data for the machine with the selected tool, the cutting parameters can be selected without experimentation or operator knowledge. By using the tap test data for the machine with the selected tool, the cutting parameters can be selected based on engineering information.

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 710 through operation 730 may be optional. For example, operation 810 through operation 820 may be optional.

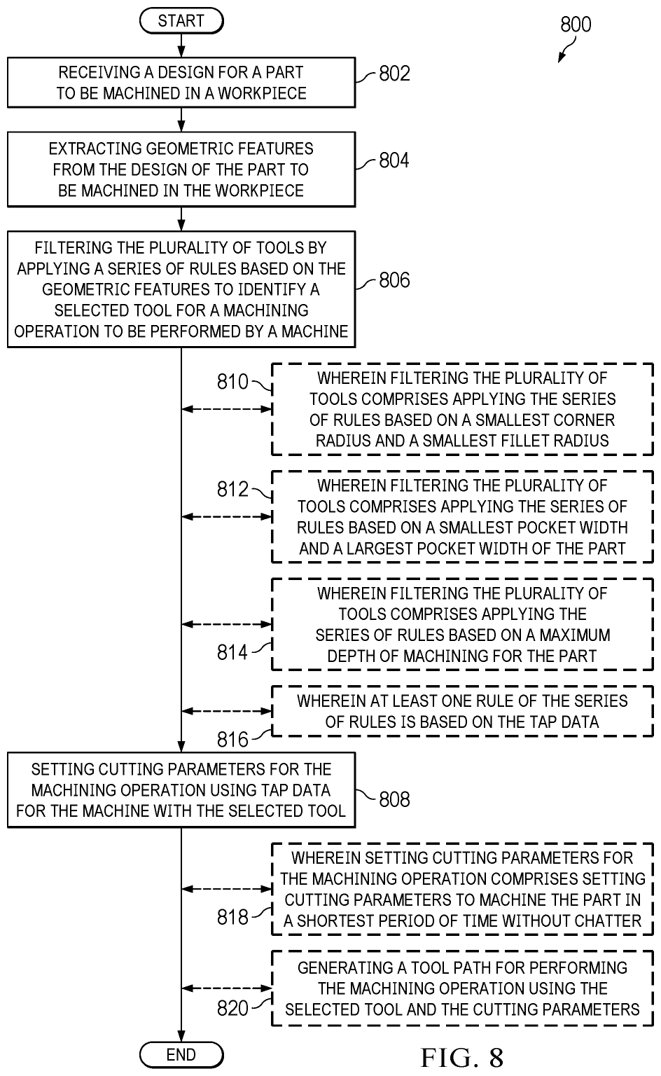

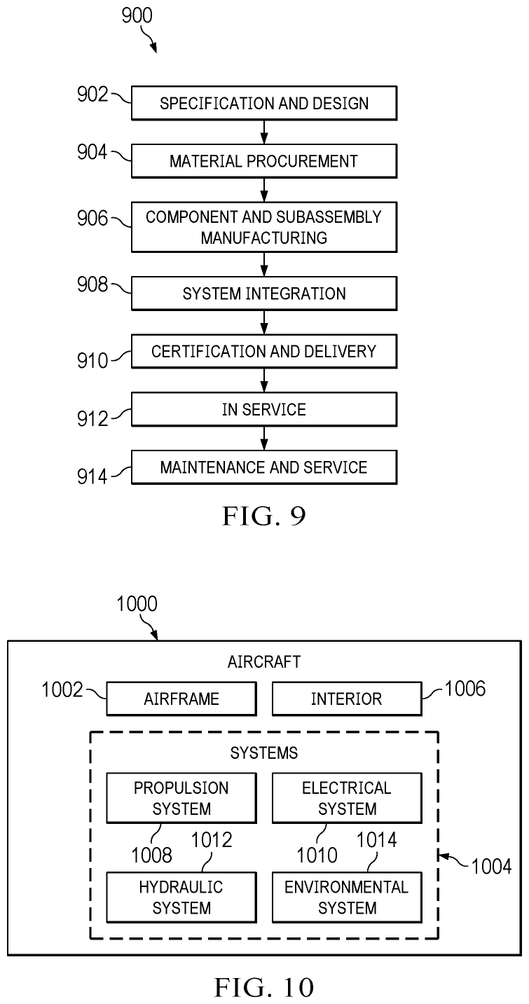

Illustrative embodiments of the present disclosure may be described in the context of aircraft manufacturing and service method 900 as shown in FIG. 9 and aircraft 1000 as shown in FIG. 10. Turning first to FIG. 9, an illustration of an aircraft manufacturing and service method in a form of a block diagram is depicted in accordance with an illustrative embodiment. During pre-production, aircraft manufacturing and service method 900 may include specification and design 902 of aircraft 1000 in FIG. 10 and material procurement 904.

During production, component and subassembly manufacturing 906 and system integration 908 of aircraft 1000 takes place. Thereafter, aircraft 1000 may go through certification and delivery 910 in order to be placed in service 912. While in service 912 by a customer, aircraft 1000 is scheduled for routine maintenance and service 914, which may include modification, reconfiguration, refurbishment, or other maintenance and service.

Each of the processes of aircraft manufacturing and service method 900 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 10, an illustration of an aircraft in a form of a block diagram is depicted in which an illustrative embodiment may be implemented. In this example, aircraft 1000 is produced by aircraft manufacturing and service method 900 of FIG. 9 and may include airframe 1002 with plurality of systems 1004 and interior 1006. Examples of systems 1004 include one or more of propulsion system 1008, electrical system 1010, hydraulic system 1012, and environmental system 1014. Any number of other systems may be included.

Apparatuses and methods embodied herein may be employed during at least one of the stages of aircraft manufacturing and service method 900. One or more illustrative embodiments may be manufactured or used during at least one of component and subassembly manufacturing 906, system integration 908, in service 912, or maintenance and service 914 of FIG. 9.

The illustrative examples provide an automated method for selecting optimized cutting tools and cutting parameters from a technical database for rapid manufacturing processes. The illustrative examples utilize a technical database of standard cutting tools and parameters specific to a machine. The technical database links the cutting tools optimal cutting parameters to dynamic tap test data. Geometry definition is extracted from the engineering design part, stock, fixture, and other features of the rapid manufacturing process. Tool filtering applies rules to the database to extract the optimized cutting tool for the machining sequences for rapid manufacturing processes using mathematically analyzed geometry of the part.

The illustrative examples reduce cost and inventory by utilizing tools that are standardized for the machine and process rather than having unlimited selection of tools and types. The illustrative examples select from a standard list of tools to rapidly manufacture a job rather than use tools not already loaded in the machine and in stock inventory. The illustrative examples also develop strategies to determine the rules required to select the most optimal cutting tool for each type of machining sequence based on geometry and a technical database of cutting tools. The illustrative examples apply dynamic tap test methodology to ensure machining stability of the cutting tool while linking those parameters with each cutting tool assembly. Efficiency and flexibility provide a competitive advantage in rapid manufacturing or low rate parts. Non-recurring efforts for manufacturing cannot be spread over a large quantity of parts as higher rate production. The illustrative examples provide a technically advanced solution for rapid manufacturing of low rate parts because the non-recurring is drastically reduced by automating a solution to determine the optimal cutting tools for each sequence and a scientific approach of dynamic tap test allows for stable cutting parameters during machining.

Conventional CAM requires the user to manually select and determine all the cutting tools and parameters. The illustrative examples automatically select cutting tools for machining operations and links dynamic tap test cutting parameters to cutting tool libraries.

The technical database also provides the tool parameters (diameter, flute length, corner radius and etc.) and tool attributes (speeds, feeds, roughing or finishing, etc.) The illustrative examples analyze and capture the geometry definition in way that is flexible and can adapt to any new part. As geometries vary the selection of tool must also vary and adapt appropriately so it can machine all of the features optimally. The illustrative examples analyze the geometry definition to extract from the engineering design part, stock, fixture, and other features of the rapid manufacturing process. Variables are then extracted and set to determine stock height, machining final depth, number of levels to machine, ratio depth to width for workpiece flexibility, pocket maximum width, pocket minimum width, smallest corner radius and smallest fillet radius. These variables are critical items that are captured to know every geometry for automation.

The tool filtering utilizes rules that are applied to mathematically analyze the geometry and database and extract the optimized cutting tool for the machining sequences for rapid manufacturing processes. Automated Rapid Manufacturing has standard machining sequences that are applied to each part. For instance, roughing, rest roughing, finish floor, finish walls and rest finish operations demonstrate a machine sequence of operations. The illustrative examples apply tool filtering rules and criteria based on cutting tool technical database and variable of the geometry definition for a roughing machining sequence. No current solution can automatically adapt to select the optimal cutting tools with new geometries and establish cutting parameters to ensure stable cutting tool machining parameters.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of tool and parameter selection comprising:
generating tap test data for a machine by performing tap testing on the machine with a plurality of tools;
extracting geometric features of a part to be machined in a workpiece by the machine from a design of the part;
filtering the plurality of tools by applying a series of rules based on the geometric features of the part to identify a selected tool for a machining operation to form the part; and
setting cutting parameters for the machining operation using the tap test data for the machine with the selected tool.

2. The method of claim 1, wherein extracting geometric features of the part comprises identifying a smallest corner radius of a feature of the part.

3. The method of claim 2, wherein filtering the plurality of tools comprises applying a rule of the series of rules that reduces the plurality of tools to a subset based on the smallest corner radius and diameters of the plurality of tools.

4. The method of claim 1, wherein extracting geometric features of the part comprises identifying a minimum pocket width of the part.

5. The method of claim 4, wherein filtering the plurality of tools comprises applying a rule of the series of rules that reduces the plurality of tools to a subset based on the minimum pocket width and diameters of the plurality of tools.

6. The method of claim 1, wherein extracting geometric features of the part comprises identifying a smallest corner fillet radius of a feature of the part.

7. The method of claim 6, wherein filtering the plurality of tools comprises applying a rule of the series of rules that reduces the plurality of tools to a subset based on the smallest corner fillet radius and corner radiuses of the plurality of tools.

8. The method of claim 1 further comprising:
saving the tap test data in a technical database with tool parameters and tool attributes for the plurality of tools, associating respective tap test data with each of the plurality of tools.

9. The method of claim 1, wherein at least one rule of the series of rules is based on the tap test data.

10. The method of claim 1 further comprising:
generating a tool path for performing the machining operation using the selected tool and the cutting parameters.

11. The method of claim 1 further comprising:
generating additional tap test data for the machine by performing tap testing on the machine with a new tool.

12. The method of claim 1, wherein setting cutting parameters for the machining operation comprises setting cutting parameters to machine the part in a shortest period of time without chatter.

13. A tool and cutting parameter selection system comprising:
a database populated with tool parameters and tool attributes for a plurality of tools and tap test data generated through tap testing for a machine with the plurality of tools;
a geometry analyzer configured to extract geometric features for a part to be machined in a workpiece;
a tool filter configured to apply a series of rules based on geometric features to identify a selected tool for machining operations to form the part in the workpiece; and
a cutting parameter selector configured to set cutting parameters based on the selected tool and the tap test data.

14. The tool and cutting parameter selection system of claim 13 further comprising:
a vibration sensor configured to attach to a tool of the plurality of tools during tap testing; and
an impact force sensor associated with a tap testing hammer.

15. A method of tool and parameter selection comprising:
receiving a design for a part to be machined in a workpiece;
extracting geometric features from the design of the part to be machined in the workpiece;
filtering a plurality of tools by applying a series of rules based on the geometric features to identify a selected tool for a machining operation to be performed by a machine; and
setting cutting parameters for the machining operation using tap test data for the machine with the selected tool.

16. The method of claim 15 further comprising:
generating a tool path for performing the machining operation using the selected tool and the cutting parameters.

17. The method of claim 15, wherein filtering the plurality of tools comprises applying the series of rules based on a smallest corner radius and a smallest fillet radius.

18. The method of claim 15, wherein filtering the plurality of tools comprises applying the series of rules based on a smallest pocket width and a largest pocket width of the part.

19. The method of claim 15, wherein filtering the plurality of tools comprises applying the series of rules based on a maximum depth of machining for the part.

20. The method of claim 15, wherein setting cutting parameters for the machining operation comprises setting cutting parameters to machine the part in a shortest period of time without chatter.

21. The method of claim 15, wherein at least one rule of the series of rules is based on the tap test data.
